(19) United States
(12) Patent Application Publication
(10) Pub. No.: US 2002/0101120 A1
(43) Pub. Date: Aug. 1, 2002

(54) Stepping motor

(76) Inventors: Kazunori Akama, Tokyo (JP); Yasuhiro Ito, Tokyo (JP); Tsuyoshi Hiroshima, Tokyo (JP)

Correspondence Address: McGuire Woods, Tysons Corner, 1750 Tysons Boulevard, Suite 1800, McClean, VA, 22102-4215, US

(21) Appl. No.: 09/771,679

(22) Filed: Jan. 30, 2001

(51) Int. Cl. H02K 37/10; H02K 37/12

(52) U.S. Cl. 310/49 R; 310/89; 310/194; 310/254

(57) ABSTRACT

A cylindrical rotor magnet is magnetized in a circumferential direction thereof. A plurality pairs of stator yokes are arranged in an axial direction of the rotor magnet so as to surround the magnet rotor. Each pair of stator yokes is associated with one phase of the motor. A case member holds the stator yokes from both sides in the axial direction of the rotor magnet. A resin member separates the pairs of stator yokes which are associated with adjacent phases of the motor. The resin member further separates the stator yokes from the case member.

### BACKGROUND OF THE INVENTION

The present invention relates to a stepping motor, and more particularly, to an improved yoke unit for accommodating a rotor.

The related stepping motor has been constructed as shown in FIGS. 4 and 5, for example.

In FIG. 4, a stepping motor 1 is composed of a hollow cylindrical case 2 with its one end open, a bracket 3 for closing the open end of the case 2, a stator 4 provided along an inner peripheral face of the case 2, and a rotor 5 which is rotatably supported by bearing portions 2a, 3a respectively provided in the case 2 and the bracket 3.

The above mentioned case 2 is formed of metallic material, and provided with the bearing portion 2a near a center of its closed end face.

The above mentioned bracket 3 is similarly formed of metallic material, and provided with the bearing portion 3a near its center:

The above mentioned stator 4 is composed of a substantially cylindrical yoke unit 6 in which four stator yokes 6a, 6b, 6c, and 6d having an outer diameter substantially equal to an inner diameter of the case 2 so as to be accommodated within the case 2 are integrally molded by a resin bobbin 7; and coils 8a, 8b which are wound around coil winding parts defined between the stator yokes 6a, 6b and between the stator yokes 6c, 6d. The stator 4 is adapted to be accommodated in the case 2, after the coils 8a, 8b have been wound, and fixed to be retained therein.

The above mentioned rotor 5 is composed of a rotary shaft 5a which is rotatably supported by the above mentioned bearing portions 2a, 3a, and a hollow cylindrical rotor magnet 5b which is fixed to the rotary shaft 5a to be retained. This rotor magnet 5b has an outer diameter which is slightly smaller than an inner diameter of a central bore in the yoke unit 6, and has been magnetized in a circumferential direction.

The above mentioned stator yokes 6a, 6b, 6c, 6d are constructed, for example, in such a manner as shown in FIG. 6.

FIG. 6 shows the stator yoke 6a only, because all the stator yokes 6a to 6d have the same shape.

In FIG. 6, the stator yoke 6a which is formed of conductive metallic material consists of an annular flange portion 6e and a number of comb-teeth-like pole projections 6f which are provided in an upright manner at an inner peripheral edge of the annular flange portion 6e.

Then, the four stator yokes 6a to 6d are assembled in such a manner that the stator yokes 6b, 6c are opposed to each other back to back and the pole projections 6f of a pair of the stator yokes 6a, 6b are deviated in phase with respect to the pole projections 6f of another pair of the stator yokes 6c, 6d by a determined value. The four stator yokes 6a to 6d thus assembled to one another are accommodated in a mold for molding the bobbin 7, and thus, the bobbin 7 formed of resin is integrally molded around the stator yokes 6a to 6d. The yoke unit 6 is completed in this manner.

In the illustrated case, the stepping motor 1 has a flange 9 at the closed end of the case 2, and adapted to be fitted to an electronic apparatus to which the stepping motor 1 is supplied by screws or the like.

In the stepping motor 1 which has been thus constructed, by feeding driving electric current through the coils 8a, 8b of the stator 4, magnetic fields generated around the coils 8a, 8b interact with a magnetic field of the rotor magnet 5b through the respective stator yokes 6a, 6b, 6c, 6d of the yoke unit 6, On this occasion, through an action of the pole projections 6f of the stator yokes 6a, 6b, 6c, 6d, the rotor 5 is intermittently actuated to rotate.

In the stepping motor 1 having such a structure, the stator yokes 6a to 6d of the yoke unit 6 have been integrally molded by the bobbin 7 formed of resin, as shown in FIGS. 4 and 5. This resin formed bobbin 7 serves to fill spaces between the pole projections 6f of the stator yokes 6a to 6d

Accordingly, the stator yokes 6a and 6d at both ends are tightly fitted to the end face of the case 2 and a surface of the bracket 3 respectively, while the inner stator yokes 6b and 6c are tightly fitted to each other back to back. Therefore, magnetic fluxes of magnetic circuits which are constituted by respective pairs of the stator yokes 6a, 6b and 6c, 6d and the respective coils 8a, 8b apt to leak to each other.

By the way, in the stepping motor 1 in case of so-called one phase excitation, when the rotor 5 sequentially stops with respect to the pole projections 6f of the stator yokes 6a to 6d at rotor stopping positions which are represented by signs S1, S2, S3, S4 . . . as shown in FIG. 7, its magnetic center is switched as shown by signs A, C, B, D theoretically.

However, when the above described leakage of the magnetic fluxes has occurred, the magnetic flux of the stator yoke 6c leaks to the stator yoke 6b a little at the stopping position S2, for example. Thus, the magnetic center will be slightly deviated from the position C toward the position B, and an actual stopping position of the rotor 5 will be also deviated toward the position B.

In the same manner, the magnetic flux of the stator yoke 6b also leaks to the stator yoke 6c a little at the stopping position S2, and effects of their excitation are reduced with each other. Thus, the magnetic center will be slightly deviated from the position B toward the position C, and the actual stopping position of the rotor 5 will be also deviated toward the position C.

In order to decrease such deviation of the stopping positions of the rotor 5 due to the leakage of the magnetic fluxes, there has been a method of correcting the stopping positions, by changing dimensions of the comb teeth like pole projections 6f in the respective phases to balance the magnetic forces at the respective pole projections 6f, or by slightly deviating an assembling angle between the stator yokes 6b and 6c from a theoretical angle. However, since variations of the magnetic forces in the respective pole projections 6f change according to states of the coil windings or a combination of strong and weak magnetic forces of the rotor, it has been difficult to completely correct the deviations of the stopping positions.

In contrast, in the stepping motor 1 in case of so-called two phase excitation, when the rotor 5 sequentially stops with respect to the pole projections 6f of the stator yokes 6a to 6d at the rotor stopping positions which are represented by the signs S1, S2, S3, S4 . . . as shown in FIG. 8, since D and A are excited at the stopping position S1 theoretically, the magnetic center corresponds to an intermediate position between them, that is, the stopping position S1. In the same manner, A and C are exited at the stopping position S2, C and B are exited at the stopping position S3, and further, B and D are exited at the stopping position S4. Accordingly, the magnetic centers correspond to respective intermediate positions between them, which are the stopping positions S2, S3 and S4.

However, when the above described leakage of the magnetic fluxes has occurred, the magnetic force of the case 2 is added to the stator 6a at the stopping position 82 for example, and the magnetic force at A becomes stronger than the magnetic force at C. With this fact; the magnetic center is slightly deviated toward A, and the actual stopping position of the rotor 5 will be deviated toward A.

In the same manner, the magnetic force of the bracket 3 is added to the stator yoke 6d at the stopping position S4, and the magnetic force at D becomes stronger than the magnetic force at B. Accordingly, the magnetic center is slightly deviated toward D, and the actual stopping position of the rotor 5 will be deviated toward D.

Heretofore, there has been such a problem that angular accuracy of the stepping motor is deteriorated, because the leakage of the magnetic fluxes occurs due to the fact that the stator yokes 6b and 6c, are tightly fitted to each other while the stator yokes 6a and 6d are tightly fitted to the case 2 and the bracket 3 respectively, and the stopping positions of the rotor 5 are deviated.

There has been a further problem that the variations of the magnetic forces may increase vibration and noise of the stepping motor 1 on occasion of continuous actuation, because uniformity of the magnetic forces will be lost by such leakage of the magnetic fluxes.

### SUMMARY OF THE INVENTION

It is an object of the present invention to provide a stepping motor in which a leakage of the magnetic fluxes in the stator yokes can be decreased with a simple structure, improving angular accuracy of the stepping motor, and at the same time, vibrations and noises can be reduced

In order to achieve the above object, according to the present invention, there is provided a stepping motor comprising:

a cylindrical rotor magnet magnetized in a circumferential direction thereof

a plurality pairs of stator yokes arranged in an axial direction of the rotor magnet so as to surround the magnet rotor, each pair of stator yokes associated with one phase of the motor;

a case member for holding the stator yokes from both sides in the axial direction of the rotor magnet; and

a resin member for separating the pairs of stator yokes which are associated with adjacent phases of the motor.

In this configuration, a leakage of magnetic fluxes between the stator yokes which are associated with the adjacent phases of the motor will be decreased, and magnetic reduction due to mutual magnetic interference can be decreased. This eliminates deviation of stopping positions of the rotor with respect to pole projections of the stator yokes, thus enhancing angular accuracy of the stepping motor.

According to the present invention, there is also provided a stepping motor comprising:

a cylindrical rotor magnet magnetized in a circumferential direction thereof;

a plurality pairs of stator yokes arranged in an axial direction of the rotor magnet so as to surround the magnet rotor, each pair of stator yokes associated with one phase of the motor;

a case member for holding the stator yokes from both sides in the axial direction of the rotor magnet; and

a resin member for separating the stator yokes from the case member.

In this configuration, outer faces of the axially outermost stator yokes are spaced from the case members. Accordingly, because magnetic interference from the case members to the outermost stator yokes are decreased by the resin member, influence of the magnetic interference on the stator yokes can be excluded, even though a specification of the case member are changed. This eliminates deviation of the stopping positions of the rotor with respect to the pole projections of the stator yokes; thus enhancing the angular accuracy of the stepping motor.

Because the case member and the stator yoke pairs associated with the respective phases are magnetically independent from each other, the magnetic reduction and the magnetic interference therebetween are decreased. Accordingly, the magnetic forces of the stator yokes are made uniform, and occurrence of vibrations or noises on occasion of the continuous actuation will be restrained.

In the above configurations, preferably, the resin member has a thickness of 0.35 mm or more.

In this case, magnetic gaps constituted by the resin layers will be larger than the gap between the rotor and the stator which has been usually about 0.35 mm or less, and the influence of the magnetic reduction and the magnetic interference can be reliably excluded.

More preferably, the resin member has a thickness in a range from 0.4 mm to 1.0 mm.

In this case, the resin member more reliably eliminates the influence of the magnetic reduction and the magnetic interference, and at the same time, enables the stepping motor itself to be formed relatively compact.

Preferably, the resin member is formed as a part of a bobbin for molding the stator yokes.

In this case, since molding of the resin member on the stator yokes is conducted at the same time with the molding of the bobbin, this can be easily realized by changing a shape of the bobbin, for example.

Moreover, since there will be no need of additional working process or material, the cost will not be remarkably increased.

### BRIEF DESCRIPTION OF THE DRAWINGS

In the accompanying drawings:

FIG. 1 is a schematic sectional view showing a stepping motor according to one embodiment of the invention;

FIG. 2 is a schematic sectional view showing stator yokes and resin layers in the stepping motor in FIG. 1 in a molded state;

FIG. 3A is a schematic sectional view taken along a line X-X in FIG. 2;

FIG. 3B is a schematic sectional view showing a modified example of FIG. 3A;

FIG. 4 is an exploded perspective view showing a structure a related stepping motor;

FIG. 5 is a schematic sectional view of the stepping motor in FIG. 4;

FIG. 6 is an enlarged perspective view of a stator yoke in the stepping motor in FIG. 4;

FIG. 7 is a view showing leakage of magnetic fluxes in the stepping motor in FIG. 4 in case of one phase excitation; and

FIG. 8 is a view showing leakage of magnetic fluxes in the stepping motor in FIG. 4 in case of two phase excitation.

### DETAILED DESCRIPTION OF THE PREFERRED EMBODIMENTS

There will be described below in detail one preferred embodiment of the present invention with reference to the accompanying drawings.

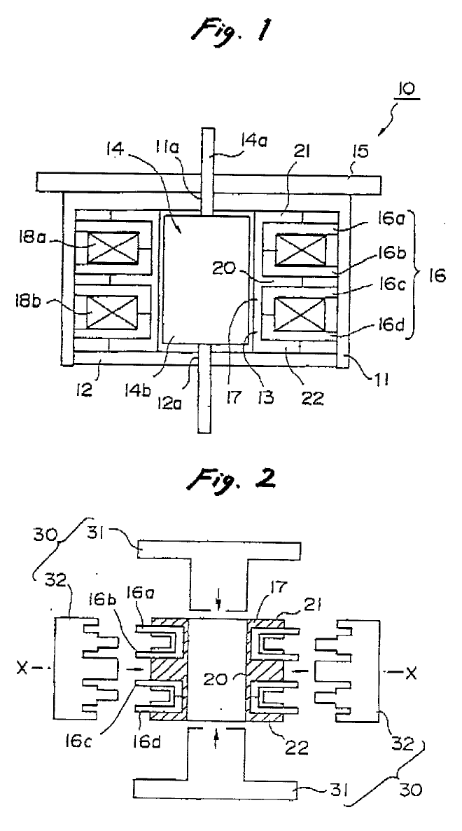

FIG. 1 shows a structure of a stepping motor according to one embodiment of the invention.

In FIG. 1, a stepping motor 10 is composed of a hollow cylindrical case 11 with its one end open, a bracket 12 for closing the open end of the case 11, a stator 13 provided along an inner peripheral face of the case 11, a rotor 14 which is rotatably supported by bearing portions 11a, 12a respectively provided in the case 11 and the bracket 12, and a flange 15 fitted to the closed end of the case 11.

The above mentioned case 11 is formed of metallic material, and provided with the bearing portion 11a near a center of its closed end face.

The above mentioned bracket 12 is similarly formed of metallic material, and provided with the bearing portion 12a near its center.

The above mentioned stator 13 is composed of: a substantially cylindrical yoke unit 16 in which four stator yokes 16a, 16b, 16c, and 16d having an outer diameter substantially equal to an inner diameter of the case 11 so as to be accommodated within the case 11 are integrally molded by a bobbin 17; and coils 18a, 18b wound around coil winding parts which are defined between the stator yokes 16a and 16b, and between the stator yokes 16c and 16d. The stator 13 is adapted to be accommodated in the case 11, after the coils 18a, 18b have been wound, and fixed to be retained therein.

The above mentioned rotor 14 is composed of a rotary shaft 14a, which is rotatably supported by the above mentioned bearing portions 11a, 12a, and a hollow cylindrical rotor magnet 14b which is fixed to the rotary shaft 14a to be retained. This rotor magnet 14b has an outer diameter which is slightly smaller than an inner diameter of a central bore in the yoke unit 16, and has been magnetized in a circumferential direction.

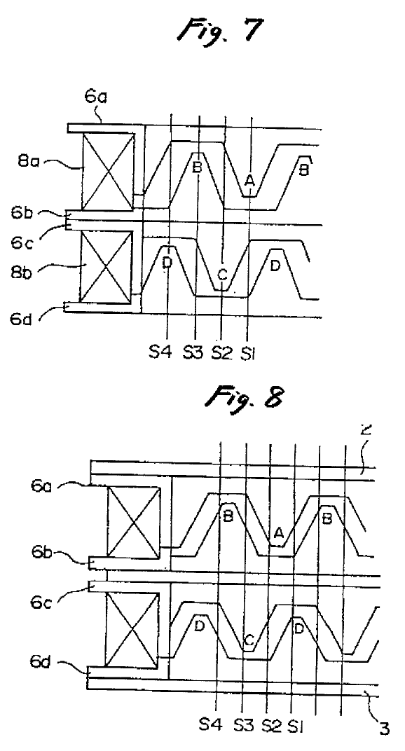

The above mentioned stator yokes 16a, 16b, 16c, and 16d are made of conductive metallic material in the same manner as the stator yoke 6a as shown in FIG. 6 for example, each of which is composed of an annular flange portion 6e and a number of comb teeth like pole projections 6f which are provided in an upright manner at an inner peripheral edge of the annular flange portion.

Then, the four stator yokes 16a to 16d are assembled in such a manner that the stator yokes 16b, 16c, are opposed back to back and the pole projections of the stator yokes 16a, 16b in one phase are deviated in phase with respect to the pole projections of the stator yokes 6c, 6d in the other phase by a predetermined value (90 degree, for example). The four stator yokes 16a to 16d thus assembled to one another are accommodated in a mold for molding the bobbin 17, and thus, the bobbin 17 formed of resin is molded integrally around the stator yokes 16a to 16d The yoke unit 16 is completed in this manner.

Although the above described structure is substantially the same as that of the related stepping motor 1 which has been shown in FIGS. 5 and 6, the stepping motor 10 according to the invention has a different structure in the following respects.

Specifically, there is formed a resin layer 20 having a predetermined thickness between the stator yokes in the respective phases, for example, between the stator yokes 16b and 16c, and further, there are formed resin layers 21 and 22 having a predetermined thickness on axially outer faces of the stator yokes 16a, 16d of respective phases facing with exterior members, which are the case 11 and the bracket 12.

The thickness of the resin layers 20, 21, 22 is selected to be 0.35 mm or more, for example. Thus, magnetic gaps constituted by the resin layers 20, 21, 22 will be larger than a gap between the rotor 14 and the stator 13 which has been usually about 0.35 mm or less, and influence of magnetic reduction or magnetic interference will be reliably eliminated.

Further, the thickness of the resin layers 20, 21, 22 is preferably selected to be between 0.40 mm and 1 mm, for example. This can more reliably eliminate the influence of the magnetic reduction or the magnetic interference of the stator yokes 16a to 16d, and at the same time, enables the stepping motor 10 itself to be formed relatively compact.

The above described resin layers 20, 21, 22 are integrally molded at the same time with the aforesaid bobbin 17 and from the same material.

Molding of these resin layers 20, 21, 22 can be effected by so-called insert molding by an injection molding machine 30 as shown in FIG. 2, with respect to the stator yokes 16a to 16d, by employing a mold 31 which moves in an axial direction and a mold 32 which moves in a lateral direction perpendicular to the axial direction.

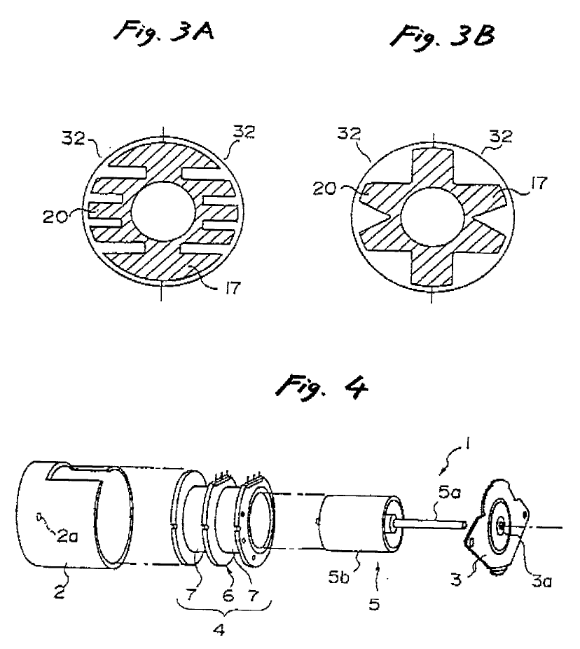

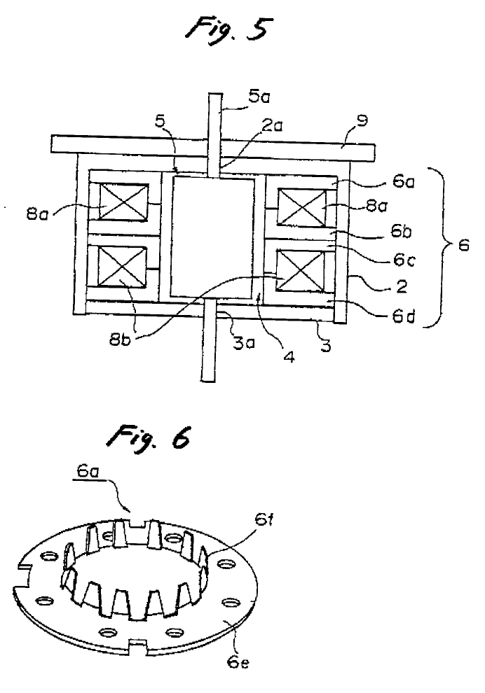

In this case, because retracting direction of the mold for the central resin layer 20 is limited to only the lateral direction, a shape of the: resin layer 20 in cross section will be either so-called striped as shown in FIG. 3A or polygonal as shown in FIG. 3B so that the mold may be extracted in the lateral direction.

By employing such molds 31, 32, the stator yokes 16a to 16d can be positioned and fixed to one another by the resin. Further, due to such striped or polygonal shape in cross section, an amount of resin material to be used for the resin layers 20, 21, 22 can be decreased, and strength can be assured.

In the stepping motor 10 according to the embodiment of the invention which is constructed as above, by feeding the driving current through the coils 18a, 18b which are wound around the coil winding parts of the yoke unit 16 of the stator 11, the magnetic fields generated around the coils 18a, 18b interact with the magnetic field of the rotor magnet 14b through the respective stator yokes 16a to 16d of the yoke unit 16. On this occasion, through action of the pole projections of the respective stator yokes 16a to 16d, the rotor 14 is intermittently actuated to rotate.

In this case, because there is arranged the resin layer 20 between the stator yokes 16b and 16c which are assembled back to back with each other, these stator yokes 16b and 16c are spaced from each other by the distance corresponding to the thickness of the resin layer 20. Therefore, the leakage of the magnetic fluxes between the stator yokes 16b and 16c which are opposed back to back interposing the resin layer 20 will be reduced, and the magnetic reduction due to the magnetic interference can be decreased. This can eliminate the deviation of the stopping positions of the rotor with respect to the comb teeth like pole projections of the stator yokes 16a to 16d, thus: enhancing the angular accuracy of the stepping motor 10.

Moreover, because there are arranged the resin layers 21, 22 respectively between the axially outer faces of the outermost stator yokes 16a, 16d and the exterior members, which are the case 11 and the bracket 12, these stator yokes 16a, 16d are spaced from the case 11 and the bracket 12 respectively by the distance corresponding to the thickness of the resin layers 21, 22. Accordingly, the magnetic interferences from the case 11 and the bracket 12 to the stator yokes 16a, 16d are decreased by the resin layers 21, 22, the influence of the magnetic interference on the stator yokes 16a, 16d can be excluded. This can eliminate deviation of the stopping positions of the rotor with respect to the comb teeth like pole projections of the stator yokes, thus enhancing the angular accuracy of the stepping motor. In this case, even though the case 11 and the bracket 12 are modified because of presence of the resin layers 21, 22, the magnetic interference to the stator yokes 16a, 16d will not be affected.

Although in the above described embodiment, the yoke unit 16 has the stator yokes 16a to 16d in the two phases, it is apparent that the invention is not limited to this embodiment, but can be applied to a stepping motor having stator yokes in three phases or more.

What is claimed is:

1. A stepping motor comprising:
a cylindrical rotor magnet magnetized in a circumferential direction thereof;
a plurality pairs of stator yokes arranged in an axial direction of the rotor magnet so as to surround the magnet rotor, each pair of stator yokes associated with one phase of the motor;
a case member for holding the stator yokes from both sides in the axial direction of the rotor magnet; and
a resin member for separating the pairs of stator yokes which are associated with adjacent phases of the motor.

2. The stepping motor as set forth in claim 1, wherein the resin member further separates the stator yokes from the case member.

3. The stepping motor as set forth in claim 1, wherein the resin member has a thickness of 0.35 mm or more.

4. The stepping motor as set forth in claim 3, wherein the resin member has a thickness in a range from 0.4 mm to 1.0 mm.

5. The stepping motor as set forth in claim 1, wherein the resin member is formed as a part of a bobbin for molding the stator yokes.

6. A stepping motor comprising:
a cylindrical rotor magnet magnetized in a circumferential direction thereof;
a plurality pairs of stator yokes arranged in an axial direction of the rotor magnet so as to surround the magnet rotor, each pair of stator yokes associated with one phase of the motor;
a case member for holding the stator yokes from both sides in the axial direction of the rotor magnet; and
a resin member for separating the stator yokes from the case member.

7. The stepping motor as set forth in claim 6, wherein the resin member further separates the pairs of stator yokes which are associated with adjacent phases of the motor.

8. The stepping motor as set forth in claim 6, wherein the resin member has a thickness of 0.35 mm or more.

9. The stepping motor as set forth in claim 8, wherein the resin member has a thickness in a range from 0.4 mm to 1.0 mm.

10. The stepping motor as set forth in claim 6, wherein the resin member is formed as a part of a bobbin for molding the stator yokes.
